(19) United States
(12) Patent Application Publication
(10) Pub. No.: US 2006/0112796 A1
(43) Pub. Date: Jun. 1, 2006

(54) Screwdriver with teethed head

(76) Inventor: Chang-Ying Chen, Taichung Hsien (TW)

Correspondence Address: Chang-Ying Chen, 235 Chung-Ho, Box 8-24, Taipei, TW

(21) Appl. No.: 10/999,062

(22) Filed: Nov. 30, 2004

(51) Int. Cl. B25B 15/00; B25B 23/00

(52) U.S. Cl. 81/460; 81/436

(57) ABSTRACT

A screwdriver with teethed head portion comprises a cruciform head including four sheets which are arranged as a cruciform shape. Two sides of each sheet have respective wavelike teeth portions for increasing a contact area between the screwdriver and a screwed object. Each tooth in the teeth portion is arranged approximately along an axial direction of the head for driving a screw means. The screwdriver head has a great contact area with a screwing means so that they are engaged tightly. As a result the screwing means will not worn and the work can be performed efficiently.

### FIELD OF THE INVENTION

The present invention relates to cruciform screwdrivers, and in particular a screw driver with a teethed head, wherein the screw driver head has a great contact area with a screwing means so that they are engaged tightly. As a result the screwing means will not wear and the work can be performed efficiently.

### BACKGROUND OF THE INVENTION

Cruciform screwdrivers are popular means in hand work. The front end of each cruciform screwdriver has a cruciform head and a held portion which is connected to the cruciform head. Thereby the screwdriver can drive the cruciform hole of a screwing means by inserting the head into the cruciform hole and the four sheets of the head will tightly engage to the hole for screwing the screwing means.

However the prior art has the following disadvantages with reference to FIGS. 7 and 8.

In general the cruciform head of the screwdriver cannot fully match the cruciform hole of the screwing means, even the cruciform hole is larger than the head. If they are not contacted fully, it will result that only part of the head is in contact with the cruciform hole of the screwing means so that force from the head will not disperse, but is concentrated to finite points. As a result the screwing means will wear or destroyed.

Furthermore, if the screwdriver head or the screwing means are adhered with oil, it will induce that the head cannot completely adhere to the screwing means. Thus the screwdriver head slides out from the cruciform hole. However this induces some inconvenient in operation.

### SUMMARY OF THE INVENTION

Accordingly, the primary object of the present invention is to provide a screwdriver with teethed head portion, wherein the screwdriver head has a great contact area with a screwing means so that they are engaged tightly. As a result the screwing means will not worn and the work can be performed efficiently.

To achieve above objects, the present invention provides a screwdriver with a teethed head portion which comprises a cruciform head including four sheets which are arranged as a cruciform. Two sides of each sheet have respective wavelike teeth portions for increasing a contact area between the screwdriver and a screwed object. Each tooth in the teeth portion is arranged approximately along an axial direction of the head for driving a screw means. The screwdriver head has a great contact area with a screwing means so that they are engaged tightly. As a result the screwing means will not worn and the work can be performed efficiently.

The various objects and advantages of the present invention will be more readily understood from the following detailed description when read in conjunction with the appended drawing.

### BRIEF DESCRIPTION OF THE DRAWINGS

FIG. 1 is a schematic view about the screwdriver of the present invention.

FIG. 2 is another schematic view about the screwdriver of the present invention.

FIG. 3 is a partial perspective view of the screwdriver of the present invention.

FIG. 4 shows the use of the screwdriver of the present invention.

FIGS. 5 and 6 are cross sectional views along line A-A of the FIG. 4.

FIGS. 7 and 8 are schematic view showing the operation of the prior art cruciform screwdriver.

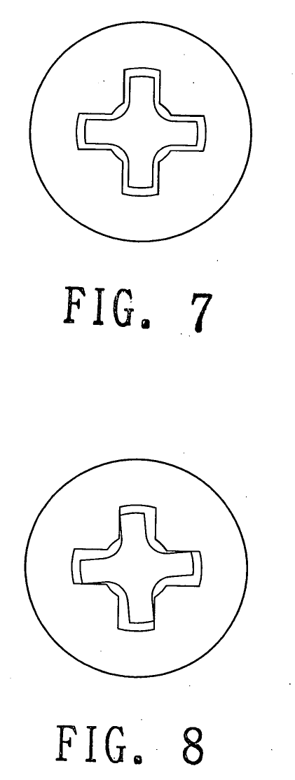

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

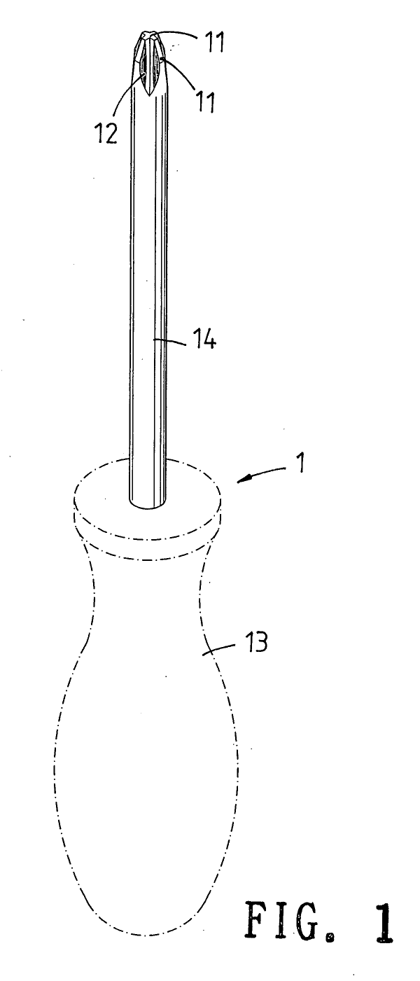

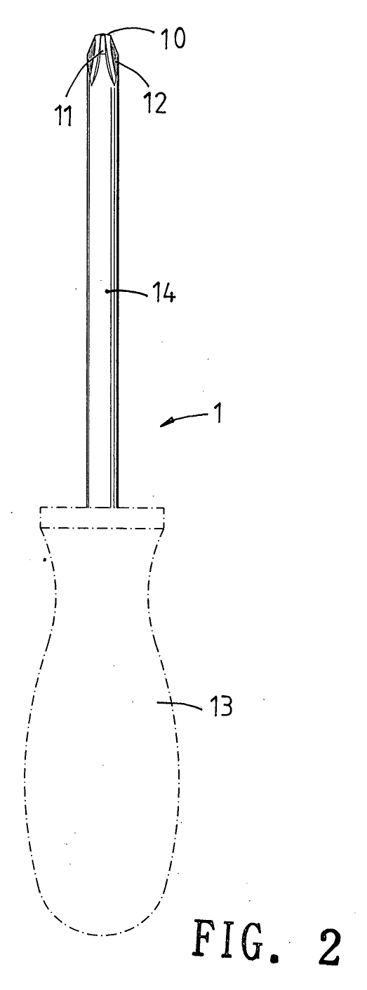

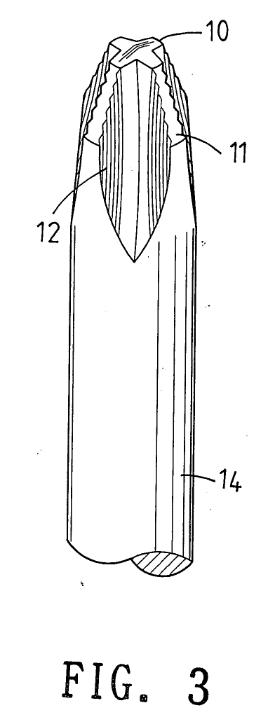

Referring to FIGS. 1 to 3, the structure of the present invention is illustrated. The present invention includes the following elements.

A screwdriver 1 is included.

A held portion 13 is at one end of the screwdriver 1.

A rod body 14 is inserted into a front end of the held portion 13. A front end of the rod body 14 is formed with a cruciform head 10. The head includes four sheets 11 which are arranged as a cruciform. Two sides of each sheet 11 have respective wavelike teeth portion 12 for increasing a contact area between the screwdriver 1 and a screwed object. Each tooth in the teeth portion 12 is arranged approximately along axial direction of the head for driving a screw means.

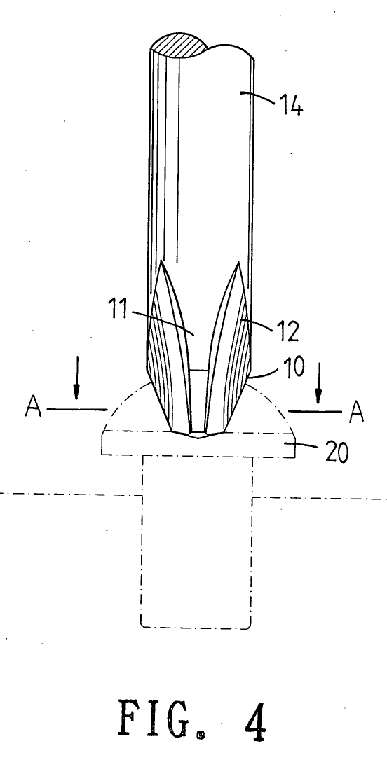

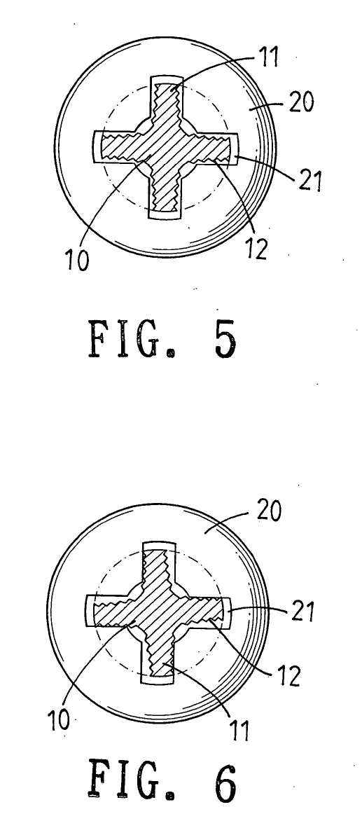

Referring to FIGS. 4 to 6, in use of the present invention, when it is desired to detach a screwing means 20, the head 10 is inserted into the cruciform hole 21 of the screwing means 20. If the size of cruciform hole 21 is slightly larger than that of the head 10, the sheets 11 of the head 10 cannot completely adhere to the cruciform hole 21 of the screwing means 20. Then, since two sides of each sheet 11 have teeth portions 12 for increasing the contact area between the head 10 and the cruciform hole 21 of the screwing means 20. Therefore the force from the head 10 to the cruciform hole 21 can be dispersed to the walls of the cruciform hole 21. Thus the force will not concentrate at some predetermined area so that the cruciform hole 21 is destroyed. This is because the teeth portions 12 of the head 10 will provide a great friction force to the cruciform hole 21. Thereby in operation, the head 10 will not fall out from the cruciform hole 21 of the screwing means 20. Thus, efficiency is increased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screwdriver with a teethed head portion comprising:
a cruciform head including four sheets which are arranged as a cruciform shape; two sides of each sheet having respective wavelike teeth portions for increasing a contact area between the screwdriver and a screwed object; each tooth in the teeth portion being arranged approximately along an axial direction of the head for driving a screw means.

2. A screwdriver with a teethed head portion comprising:
a held portion at one end of the screw driver;
a rod body inserted into a front end of the held portion; a front end of the rod body being formed with a cruciform head; the head including four sheets which are arranged as a cruciform shape; two sides of each sheet having respective wavelike teeth portions for increasing a contact area between the screw driver and a screwed object; each tooth in the teeth portion being arranged approximately along an axial direction of the head for driving a screw means.
